(19) United States
(12) Patent Application Publication
(10) Pub. No.: US 2024/0297516 A1
(43) Pub. Date: Sep. 5, 2024

(54) MANAGEMENT OF POWER TO LOADS OF A VEHICLE

(71) Applicant: GM GLOBAL TECHNOLOGY OPERATIONS LLC, Detroit, MI (US)

(72) Inventors: Chunhao J. Lee, Troy, MI (US); Dongxu Li, Troy, MI (US); Suresh Gopalakrishnan, Troy, MI (US); Lei Hao, Troy, MI (US); Chandra S. Namuduri, Troy, MI (US)

(21) Appl. No.: 18/177,522

(22) Filed: Mar. 2, 2023

(51) Int. Cl. H02J 7/00; B60L 50/50; H02M 3/04

(52) U.S. Cl. CPC H02J 7/0063; B60L 50/50; H02J 7/0068; H02M 3/04

(57) ABSTRACT

A system for supplying power to one or more electrical loads in a vehicle includes a conversion system connected to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to the one or more electrical loads. The system also includes a controller configured to operate the conversion system to electrically connect the conversion device and the pre-charge circuit to the battery system and the one or more electrical loads, the controller configured to adjust a battery system voltage from the battery system to a load voltage of the one or more electrical loads based on a mismatch between the battery system voltage and the load voltage.

### INTRODUCTION

The subject disclosure relates to vehicles, and more specifically, to controlling electrical power to high voltage accessories of a vehicle.

Vehicles, including gasoline and diesel power vehicles, as well as electric and hybrid electric vehicles, feature battery storage for purposes such as powering electric motors, electronics and other vehicle subsystems. Accessories such as power control modules, heaters and cooling systems can be powered by the vehicle battery system. In some cases, the voltage required for accessories is different than the battery voltage (i.e., voltage output by a vehicle battery system). Accordingly, mechanisms or systems for effectively adjusting battery voltages to voltages required for accessories are desirable.

### SUMMARY

In one exemplary embodiment, a system for supplying power to one or more electrical loads in a vehicle includes a conversion system connected to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to the one or more electrical loads. The system also includes a controller configured to operate the conversion system to electrically connect the conversion device and the pre-charge circuit to the battery system and the one or more electrical loads, the controller configured to adjust a battery system voltage from the battery system to a load voltage of the one or more electrical loads based on a mismatch between the battery system voltage and the load voltage.

In addition to one or more of the features described herein, the conversion system is selectively connected to the one or more electrical loads by a second bus separate from the propulsion bus, the second bus configured to support voltage levels provided by the battery system.

In addition to one or more of the features described herein, the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

In addition to one or more of the features described herein, the controller is configured to electrically connect the conversion system by sequentially performing a method that includes electrically connecting the propulsion system to the battery system, and closing the first switch to electrically connect the battery system to the conversion device, where the pre-charge contactor and the main contactor are open, pre-charging the propulsion system and the conversion device using pre-charge components in the battery system, monitoring a propulsion system voltage, an input voltage to the conversion device, and an output voltage from the conversion device, and based on a difference between the propulsion system voltage and the input voltage being less than a threshold difference, and based on the output voltage reaching a selected voltage level, closing the pre-charge contactor to pre-charge one or more capacitors of the one or more electrical loads. The method also includes monitoring a voltage of the one or more electrical loads during the pre-charge, and based on the voltage of one or more electrical loads being within a selected range of the output voltage, closing the main contactor and adjusting the input voltage by the conversion device.

In addition to one or more of the features described herein, the battery system includes a first battery assembly and a second battery assembly, and the battery system is in a high voltage mode in which the first battery assembly and the second battery assembly are electrically connected in series.

In addition to one or more of the features described herein, the battery system voltage is the same as the load voltage or the battery system voltage is within a selected range of the load voltage, and the controller is configured to electrically connect the conversion system by sequentially performing a method that includes electrically connecting the propulsion system to the battery system, and closing the second switch to bypass the conversion device and electrically connect the battery system to the pre-charge circuit, where the pre-charge contactor and the main contactor are open, closing the pre-charge contactor and opening the main contactor, and simultaneously pre-charging the propulsion system and the one or more electrical loads. The method also includes monitoring a voltage of the one or more electrical loads during the pre-charge, and based on the voltage of one or more electrical loads being within a selected range of an output voltage from the conversion device, closing the main contactor and powering the one or more electrical loads using the battery system voltage.

In addition to one or more of the features described herein, the battery system includes a first battery assembly and a second battery assembly, the battery system is configured to be put into a high voltage mode by electrically connecting the first battery assembly and the second battery assembly in series, and the battery system is configured to be put into a low voltage mode by electrically connecting the first battery assembly and the second battery assembly in parallel.

In addition to one or more of the features described herein, the propulsion system is active, the battery system is in the high voltage mode, the first switch, the pre-charge contactor and the main contactor are closed, and the controller is configured to perform a method that includes operating the conversion device to adjust an input voltage to a target voltage that is less than or equal to a voltage level corresponding to the low voltage mode, receiving a request to transition the battery system from the high voltage mode to the low voltage mode, and opening the first switch and the main contactor to isolate the conversion device. The method also includes monitoring a propulsion system voltage and an input voltage to the conversion device, based on a difference between the propulsion system voltage and the target voltage being less than a threshold difference, and based on the input voltage being less than the target voltage, closing the second switch and opening the main contactor to pre-charge one or more capacitors of the one or more electrical loads, monitoring a voltage of the one or more electrical loads during the pre-charge, and based on the voltage of one or more electrical loads being within a selected range of the target voltage, closing the main contactor and powering the one or more electrical loads using the battery voltage in the low voltage mode.

In addition to one or more of the features described herein, the propulsion system is active, the battery system is in the low voltage mode, the first switch is open and the second switch is closed, the pre-charge contactor is open and the main contactor is closed, and the controller is configured to perform a method that includes receiving a request to transition the battery system from the low voltage mode to the high voltage mode, opening the second switch and the main contactor to isolate the conversion device, and subsequently closing the first switch, monitoring a propulsion system voltage and an input voltage to the conversion device, and monitoring an output voltage from the conversion device. The method also includes, based on a first difference between the propulsion system voltage and a target voltage being less than a first threshold difference, and based on a second difference between the output voltage and the load voltage being less than a second threshold difference, closing the pre-charge contactor and opening the main contactor to pre-charge one or more capacitors of the one or more electrical loads, monitoring a voltage of the one or more electrical loads during the pre-charge, and based on a third difference between the voltage of one or more electrical loads and the output voltage of the conversion device being less than a third threshold difference, closing the main contactor and powering the one or more electrical loads using the battery voltage in the high voltage mode.

In one exemplary embodiment, a method of supplying power to one or more electrical loads in a vehicle includes electrically connecting a conversion system to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to the one or more electrical loads, pre-charging the one or more electrical loads using the pre-charge circuit or pre-charge components in the battery system, and based on a mismatch between a battery system voltage and a load voltage of the one or more electrical loads, adjusting the battery system voltage to the load voltage.

In addition to one or more of the features described herein, the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

In addition to one or more of the features described herein, electrically connecting the conversion system includes sequentially performing a method that includes electrically connecting the propulsion system to the battery system, and closing the first switch to electrically connect the battery system to the conversion device, wherein the pre-charge contactor and the main contactor are open, pre-charging the propulsion system and the conversion device using pre-charge components in the battery system, monitoring a propulsion system voltage, an input voltage to the conversion device, and an output voltage from the conversion device, and based on a difference between the propulsion system voltage and the input voltage being less than a threshold difference, and based on the output voltage reaching a selected voltage level, closing the pre-charge contactor to pre-charge one or more capacitors of the one or more electrical loads. The method also includes monitoring a voltage of the one or more electrical loads during the pre-charge, and based on the voltage of one or more electrical loads being within a selected range of the output voltage, closing the main contactor and adjusting the input voltage by the conversion device.

In addition to one or more of the features described herein, the battery system voltage is the same as the load voltage or the battery system voltage is within a selected range of the load voltage, and electrically connecting the conversion system includes sequentially performing a method that includes electrically connecting the propulsion system to the battery system, and closing the second switch to bypass the conversion device and electrically connect the battery system to the pre-charge circuit, wherein the pre-charge contactor and the main contactor are open, closing the pre-charge contactor and opening the main contactor and simultaneously pre-charging the propulsion system and the one or more electrical loads. The method also includes monitoring a voltage of the one or more electrical loads during the pre-charge, and based on the voltage of one or more electrical loads being within a selected range of an output voltage from the conversion device, closing the main contactor and powering the one or more electrical loads using the battery system voltage.

In addition to one or more of the features described herein, the battery system includes a first battery assembly and a second battery assembly, the battery system is configured to be put into a high voltage mode by electrically connecting the first battery assembly and the second battery assembly in series, and the battery system is configured to be put into a low voltage mode by electrically connecting the first battery assembly and the second battery assembly in parallel.

In addition to one or more of the features described herein, the propulsion system is active, the battery system is in the high voltage mode, the first switch, the pre-charge contactor and the main contactor are closed, and the method includes operating the conversion device to adjust an input voltage to a target voltage that is less than or equal to a voltage level corresponding to the low voltage mode, receiving a request to transition the battery system from the high voltage mode to the low voltage mode, and opening the first switch and the main contactor to isolate the conversion device, monitoring a propulsion system voltage and an input voltage to the conversion device, and based on a difference between the propulsion system voltage and the target voltage being less than a threshold difference, and based on the input voltage being less than the target voltage, closing the second switch and opening the main contactor to pre-charge one or more capacitors of the one or more electrical loads. The method also includes monitoring a voltage of the one or more electrical loads during the pre-charge, and based on the voltage of one or more electrical loads being within a selected range of the target voltage, closing the main contactor and powering the one or more electrical loads using the battery voltage in the low voltage mode.

In another exemplary embodiment, a vehicle system includes a memory having computer readable instructions, and a processing device for executing the computer readable instructions. The computer readable instructions control the processing device to perform a method that includes electrically connecting a conversion system to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to one or more electrical loads, pre-charging the one or more electrical loads using the pre-charge circuit or pre-charge components in the battery system, and based on a mismatch between a battery system voltage and a load voltage of the one or more electrical loads, adjusting the battery system voltage to the load voltage.

In addition to one or more of the features described herein, the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

In addition to one or more of the features described herein, electrically connecting the conversion system includes sequentially a method that includes electrically connecting the propulsion system to the battery system, and closing the first switch to electrically connect the battery system to the conversion device, wherein the pre-charge contactor and the main contactor are open, pre-charging the propulsion system and the conversion device using pre-charge components in the battery system, monitoring a propulsion system voltage, an input voltage to the conversion device, and an output voltage from the conversion device, and based on a difference between the propulsion system voltage and the input voltage being less than a threshold difference, and based on the output voltage reaching a selected voltage level, closing the pre-charge contactor to pre-charge one or more capacitors of the one or more electrical loads. The method also includes monitoring a voltage of the one or more electrical loads during the pre-charge, and based on the voltage of one or more electrical loads being within a selected range of the output voltage, closing the main contactor and adjusting the input voltage by the conversion device.

In addition to one or more of the features described herein, the battery system includes a first battery assembly and a second battery assembly, and the battery system is in a high voltage mode in which the first battery assembly and the second battery assembly are electrically connected in series.

In addition to one or more of the features described herein, the battery system voltage is the same as the load voltage or the battery system voltage is within a selected range of the load voltage, and electrically connecting the conversion system includes sequentially performing a method that includes electrically connecting the propulsion system to the battery system, and closing the second switch to bypass the conversion device and electrically connect the battery system to the pre-charge circuit, wherein the pre-charge contactor and the main contactor are open, closing the pre-charge contactor and opening the main contactor and simultaneously pre-charging the propulsion system and the one or more electrical loads. The method also includes monitoring a voltage of the one or more electrical loads during the pre-charge, and based on the voltage of one or more electrical loads being within a selected range of an output voltage from the conversion device, closing the main contactor and powering the one or more electrical loads using the battery system voltage.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a multi-drive propulsion system and a conversion system configured to control voltage applied to one or more electrical loads, in accordance with an exemplary embodiment;

FIG. 2 depicts components of a conversion system for controlling voltage applied to one or more electrical loads, in accordance with an exemplary embodiment;

FIG. 3 is a flow diagram depicting aspects of a method of controlling a conversion device to electrically connect one or more electrical loads to a battery system, in accordance with an exemplary embodiment;

FIG. 4 is a flow diagram depicting aspects of a method of controlling a conversion device to electrically disconnect one or more loads from a battery system, in accordance with an exemplary embodiment;

FIG. 5 is a flow diagram depicting aspects of method of controlling a conversion device to electrically connect one or more electrical loads to a battery system, in accordance with an exemplary embodiment;

FIG. 6 is a flow diagram depicting aspects of method of controlling a conversion device to electrically disconnect one or more loads from a battery system, in accordance with an exemplary embodiment;

FIG. 7 is a flow diagram depicting aspects of method of transitioning a battery system from a high voltage mode to a low voltage mode, in accordance with an exemplary embodiment;

FIG. 8 is a flow diagram depicting aspects of method of transitioning a battery system from a low voltage mode to a high voltage mode, in accordance with an exemplary embodiment;

FIG. 9 depicts components of a pre-charge circuit of a conversion device, in accordance with an exemplary embodiment;

FIG. 10 depicts components of a battery system and a conversion system, in accordance with an exemplary embodiment; and

FIG. 11 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with exemplary embodiments, methods, devices and systems are provided for controlling power supplied to electrical loads in a vehicle, and for initializing and shutting down power supplied to the electrical loads. In an embodiment, the vehicle includes a battery system that is controllable to provide variable voltage levels to a propulsion system and to accessories and/or other electrical loads. For example, the battery system includes multiple battery assemblies (e.g., battery packs) that can be connected in series to provide a high voltage, and can be connected in parallel to provide a low voltage.

It is noted that “low voltage” and “high voltage” are relative terms and are not intended to restrict voltage levels to specific values or ranges. For example, embodiments are described herein in conjunction with a low voltage of 400 V and a high voltage of 800 V; however, low and high voltages may be any desired or suitable voltage levels or ranges.

An embodiment of a conversion system is connected to the battery system and one or more electrical loads, and is configured to step down or otherwise adjust a voltage provided by the battery system (the “battery voltage”) to an output voltage that conforms to a voltage level used by the one or more electrical loads (the “load voltage”). The conversion system includes a conversion device such as a direct current (DC)-DC converter and a pre-charge circuit, which are selectively connectable to the battery system via a battery relay.

The conversion system is configured to provide for pre-charging and discharging electrical loads when initializing and shutting down the electrical loads, and is configured to control an output voltage to the electrical loads when there is a mismatch between the battery voltage and the load voltage. Embodiments described herein also include methods (including various switching sequences) for electrically connecting and disconnecting one or more electrical loads to and from the battery system using the conversion device, and methods for transitioning between voltage levels of the battery system during use of electrical loads.

Embodiments described herein present numerous advantages and technical effects. The embodiments provide effective and flexible mechanisms for controlling the voltage of power provided to electrical loads from a battery system. In addition, the conversion device described herein is able to effectively connect and disconnect electrical loads to a battery system while reducing or minimizing current transients and properly charging and discharging capacitances in the electrical loads. For example, the conversion device described herein is capable of preventing inrush currents and maintaining transient currents to within acceptable levels, while also reducing the amount of time and number of voltage increase steps to achieve a steady state output voltage, as compared to existing systems. In addition, the conversion device provides for effective power down or shutdown of electrical loads in a smooth manner (i.e., without significant transients).

The embodiments are not limited to use with any specific vehicle and may be applicable to various contexts. For example, embodiments may be used with automobiles, trucks, aircraft, construction equipment, farm equipment, automated factory equipment and/or any other device or system that includes multiple drives and/or multiple conversion devices.

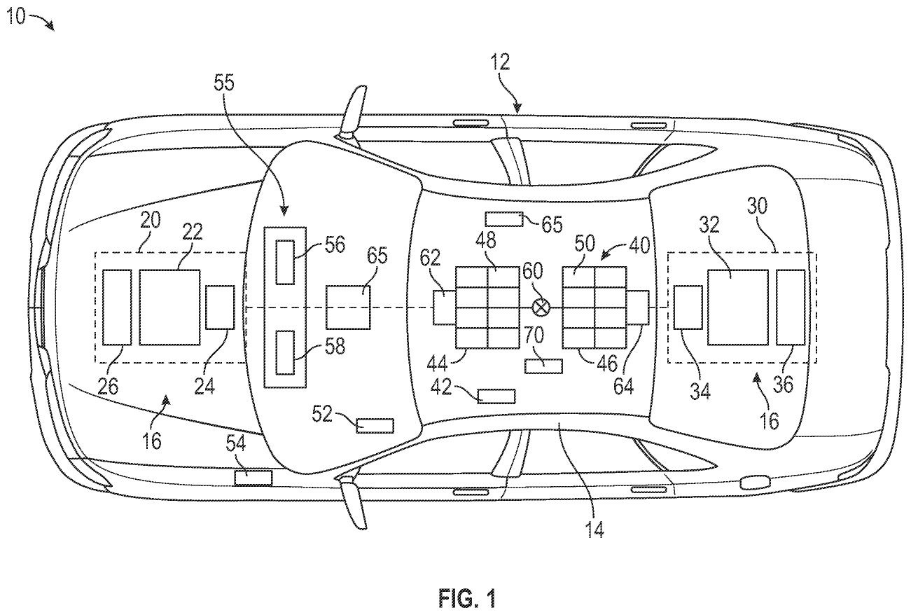

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be an electrically powered vehicle (EV), a hybrid vehicle or any other vehicle. In an embodiment, the vehicle 10 is an electric vehicle that includes multiple motors and/or drive systems. For example, the propulsion system 16 is a multi-drive system that includes a first drive unit 20 and a second drive unit 30. The first drive unit 20 includes a first electric motor 22 and a first inverter 24, as well as other components such as a cooling system 26. The second drive unit 30 includes a second electric motor 32 and a second inverter 34, and other components such as a cooling system 36. The inverters 24 and 34 (e.g., traction power inverter units or TPIMs) each convert DC power from a high voltage (HV) battery system 40 to poly-phase (e.g., two-phase, three-phase, six-phase, etc.) alternating current (AC) power to drive the motors 22 and 32.

Each of the first motor 22 and the second motor 32 is a three-phase motor having three phase motor windings. However, embodiments described herein are not so limited. For example, the first and second motors 22 and 32 may be any poly-phase machines supplied by poly-phase inverters, and the drive units can be realized using a single machine having independent sets of windings.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the first electric motor 22 drives front wheels (not shown) and the second electric motor 32 drives rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the drive unit 20 and the drive unit 30 are electrically connected to the battery system 40. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the inverter 24, and a second battery pack 46 connected to the inverter 34. The battery pack 44 includes a plurality of battery modules 48, and the battery pack 46 includes a plurality of battery modules 50. Each module 48, 50 includes a number of individual cells (not shown).

The battery system 40 and/or the propulsion system 16 includes various switching devices for controlling operation of the battery packs and selectively connecting the battery packs to the drive systems 20 and 30. The switching devices may also be operated to selectively connect the battery pack 44 and the battery pack 46 to a charging system. The charging system can be used to charge the battery pack 44 and the battery pack 46, and/or to supply power from the battery pack 44 and/or the battery pack 46 to charge another energy storage system (e.g., vehicle-to-vehicle (V2V) and/or vehicle-to-everything (V2X) charging). The charging system includes an onboard charging module (OBCM) 52 that is electrically connected to a charge port 54 for charging from an energy storage system such as a utility AC power supply.

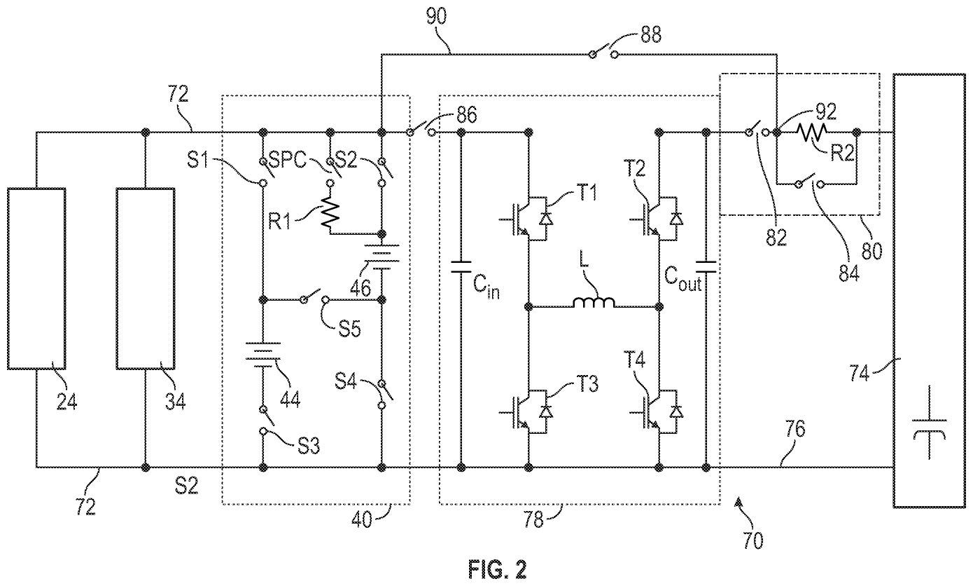

In an embodiment, the battery system 22 is controllable to apply variable voltage to the drive units and/or to other loads in the vehicle 10. For example, a switching system includes various switches at a propulsion bus (shown in FIG. 2), and at least one switching device 60 provided for selectively connecting the battery pack 44 to the battery pack 46 in series or in parallel and providing variable voltage (e.g., a voltage corresponding to the voltage of a battery pack or an average voltage) or a sum of the voltages of the battery packs. The switching system may also include switching devices 62 and 64 between the battery system 40 and the inverters 24 and 34.

The battery system 40 may also be electrically connected to other components (electrical loads), such as vehicle electronics, heating and cooling systems, lighting and others. As discussed further herein, the battery system 40 is connected to a conversion system 70 that is operable to control the amount of voltage applied to vehicle loads. For example, the conversion system 70 is connected to an auxiliary power module (APM) 42 that provides power to various loads. The conversion system 70 may also be connected to other loads.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling voltage and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

FIG. 2 depicts an embodiment of the battery system 40 and the conversion system 70. The embodiments are discussed in conjunction with the vehicle 10 and the dual drive system thereof. Embodiments are not so limited, as they can be used with any suitable vehicle system having any number of drive units and battery packs.

The conversion system 70 includes a conversion device 78 such as a DC-DC converter, and a pre-charge circuit 80. The conversion device 78 is configured to adjust (step up or step down) an input voltage received from the battery system 40, to conform the input voltage to a voltage level (referred to as a “load voltage”) associated with one or more electrical loads 74. In an embodiment, the one or more electrical loads are high voltage loads (e.g., 30 V-400 V loads or higher); however, the loads may have any load voltage.

As shown, the first inverter 24, the second inverter 34, the battery system 40 and the conversion device 78 are connected to a propulsion DC bus 72. The conversion device 70 is connected to electrical loads 74 by a separate high voltage (HV) bus 76.

In an embodiment, the conversion device 78 is a DC-DC converter that includes switches T1-T4 in an active bridge configuration. A half-bridge including the switches T1 and T3 is connected via an inductor L to a half-bridge including switches T2 and T4. The DC-DC converter also includes an input capacitor Cᵢₙ and an output capacitor Cₒᵤₜ. The switches are controllable using a pulse width modulation switching scheme to adjust the voltage provided to the one or more loads 74, by increasing or decreasing an input voltage from the battery system 40 to an adjusted output voltage.

In an embodiment, the battery system 40 is controllable to output varying voltages to the inverter 24 and/or the inverter 34. In an embodiment, the battery system 40 is controllable to output a first voltage (“low voltage”), or output a second voltage (“high voltage”), as discussed further herein. For example, the switching system can be controlled to apply a 400V nominal or average voltage or an 800V nominal or average voltage. It is noted that there may be more than two battery packs, with at least one switch between adjacent battery packs; in this case, the batteries can be connected to each other in various ways to provide more than two voltages. In addition, there may be a single battery pack having multiple parts (e.g., a single battery with switches separating parallel strings of cell); in this case, the battery system can be used to apply different voltages by connecting the strings in various ways.

For example, the battery system includes switches S1 and S3 for connecting the battery pack 44 to the propulsion bus 72, and switches S2 and S4 for connecting the battery pack 46 to the propulsion bus 72. A switch S5 is operable to selectively connect the battery pack 44 in series to the battery pack 46.

The battery packs 44 and 46 may have the same nominal voltage (e.g., 400 V), and the switches can be controlled to connect the battery packs 44 and 46 according to a high voltage mode or a low voltage mode.

In the low voltage mode, the battery packs 44 and 46 are connected in parallel to supply the low voltage (voltage is the same as the battery pack voltages). For example, to put the battery system 40 in the low voltage mode, the switches S1, S2, S3 and S4 are all closed (i.e., ON), and the switch S5 is open (i.e., OFF).

In the high voltage mode, the battery packs 44 and 46 are connected in series, and the output voltage is the sum of individual voltages of the battery packs 44 and 46. For example, to put the battery system 40 in the high voltage mode, the switch S5 is closed, the switch S1 is closed and the switch S3 is open. The switch S2 is open and the switch S4 is closed.

The battery system 40 may include one or more additional circuit components. For example, a battery pre-charge circuit includes the switch S2, and a resistor R1 and switch SPC connected in parallel with the switch S2. The battery system 40, the inverters 24 and 34 (and other connected high voltage components) can be pre-charged by opening the switch S2 and closing the switch SPC.

In the conversion system 70, the pre-charge circuit 80 includes a resistor R2 selectively connectable in series to the DC-DC converter or conversion device 78 by a pre-charge switch 82 (also referred to as a “pre-charge contactor”). A switch 84 (also referred to as a “main contactor”) is connected in parallel with the resistor R2 so that the resistor R2 is bypassed when the main contactor 84 is closed.

The conversion system 70 also includes a number of switches for facilitating transitions of operating modes of the conversion device 78. The conversion device may be put into different operating modes for adjusting output voltages of the battery system 40 based on the voltage level of the battery system 40 (e.g., a high voltage or low voltage). By putting the conversion system 70 into a proper operating mode, loads 74 can be initialized (powered up) and pre-charged, and power can be supplied to the loads 74 while minimizing or reducing inrush currents and transients.

In an embodiment, the conversion system 70 includes a first switch 86 for connecting and disconnecting the conversion device 78 from the battery system 40. The switch 86 includes, for example, a mechanical relay and may also be referred to as a “battery relay” 86.

A second switch 88 selectively connects the propulsion bus 72 to the pre-charge circuit 80, bypassing the conversion device 78. The switch 88 includes, for example, a mechanical relay referred to as a “bypass relay” 88. It is noted that the switches 86 and 88 may be any suitable type of switch (e.g., a solid state switch).

For example, the switch 88 is included in a bypass contactor 90 that connects the battery system to a node 92 between the pre-charge contactor 82 and the resistor R2. However, the conversion system 70 is not so limited, as the bypass contactor can be connected at other points (e.g., at an output side of the resistor R2 as shown in FIG. 10).

The conversion system 70 can be put into an “active mode” by closing the battery relay 86 and opening the bypass relay 88. In the active mode, current from the battery system 40 flows through the conversion device 78 and the pre-charge circuit 80, so that the one or more electrical loads 74 can be pre-charged upon activation, and voltage from the battery system 40 can be adjusted.

The conversion system 70 can be put into a “bypass mode,” in which the bypass relay 88 is closed to bypass the DC-DC converter (e.g., when the battery voltage and the load voltage are the same or similar). In the bypass mode, the pre-charge circuit can still be used for pre-charging the one or more electrical loads 74.

Any of the switches in the battery system 40 and the conversion system 70 may be any suitable type of switch, such as a mechanical contactor, electronic switch or solid state switching device. Any suitable solid state or electronic device may be employed as a switch. For example, switches can include solid state relays or transistors such as Silicon (Si) insulated gate bipolar transistors (IGBTs), and field-effect transistors (FETs). Examples of FETs include metal-oxide-semiconductor FETs (MOSFETs), Si MOSFETs, silicon carbide (Sic) MOSFETs, gallium nitride (GaN) high electron mobility transistors (HEMTs), and SiC junction-gate FETs (JFETs). Other examples of switches that can be used include diamond, gallium oxide and other wide band gap (WBG) semiconductor-based power switch devices.

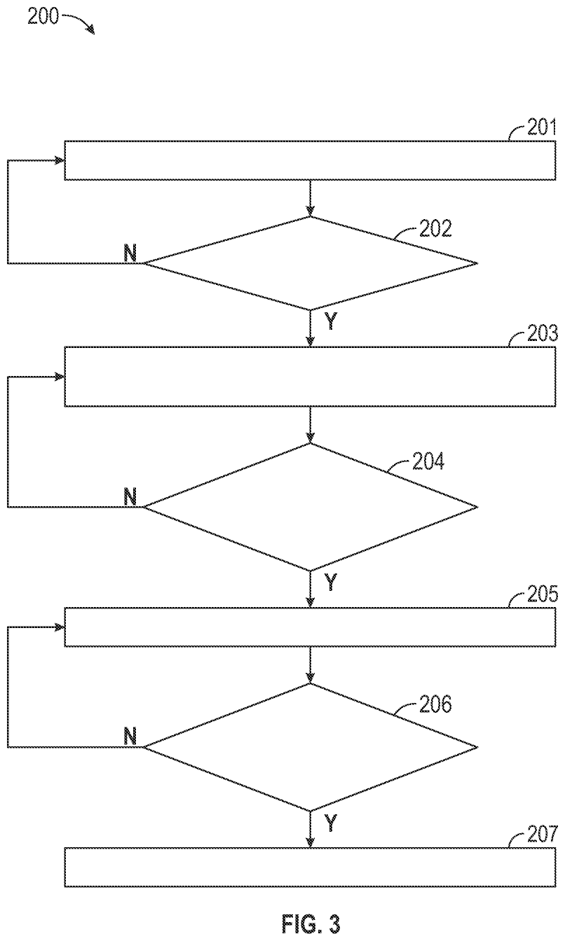

FIGS. 3-7 depict methods of controlling the conversion system 70 to facilitate connecting activating, shutting down and/or supplying power to one or more electrical loads. The methods are described in conjunction with the vehicle 10 and the conversion system of FIG. 2 for illustrative purposes. However, the methods are not so limited, as the methods may be applied to any suitable system including a conversion device and components for performing the functions described herein. Aspects of the methods may be performed by a processor or processors disposed in a vehicle, such as the controller 65. However, the methods are not so limited, as the methods may be performed by any suitable processing device or system, or combination of processing devices.

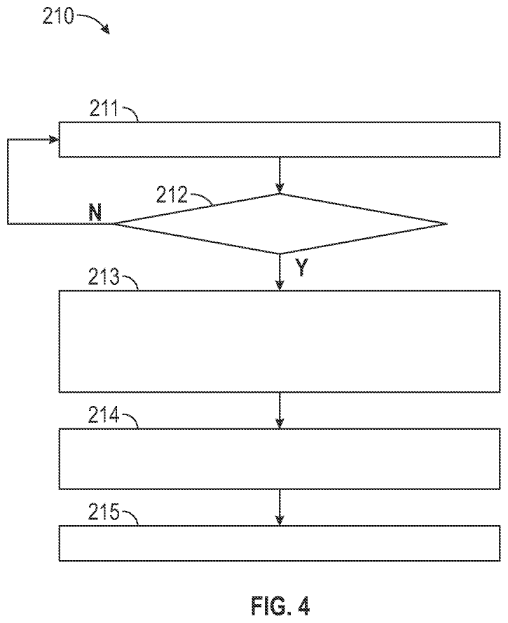

FIGS. 3 and 4 depict an embodiment of a method 200 of activating and supplying power to the one or more electrical loads 74, and an embodiment of a method 210 of de-activating or shutting down the one or more electrical loads 74 (disconnecting the loads from a battery system). The battery system 40 may be in a high voltage mode or a low voltage mode. The methods 200 and 210 are applicable in situations in which voltage of the electrical loads 74 (load voltage) is less than the battery voltage (high voltage such as 800 V). In such situations, the conversion device 70 adjusts the battery voltage to conform to the load voltage used by the loads 74.

Referring to FIG. 3, the method 200 includes a number of steps or stages represented by blocks 201-107. In an embodiment, the steps or stages are performed in the order presented. The method 200 is not limited to the number or order of steps therein, as some steps represented by blocks 201-207 may be performed in a different order than that described below, or fewer than all of the steps may be performed.

The method 200 is discussed in conjunction with the battery system 40, and is performed to adjust the battery voltage by receiving an input voltage from the battery system 40, reducing or stepping down the input voltage and providing an output voltage to the one or more loads 74 at the load voltage.

In an embodiment, the method 200 is performed when the battery system 40 is in a high voltage mode (battery packs 44 and 46 are connected in series by the switch S5). For example, the battery system 40 is in a high voltage mode in which the battery voltage is 800 V (each pack has a voltage of 400 V). The method 200 is not so limited and may be used to adjust any battery voltage (e.g., an output voltage when the battery system 40 is in a high voltage mode or a low voltage mode) to any desired load voltage.

At block 201, the controller 65 determines whether the one or more loads 74 are off or in a standby mode (i.e., the one or more loads 74 do not draw current). If the one or more loads 74 are not in the standby or off mode, the controller 65 puts the one or more loads 74 in the standby mode or sends a request to put the loads in standby.

The controller 65 also determines whether the conversion system 70 is in a standby mode. In the standby mode, the conversion device 78 is disconnected from the battery system 40, both the relay 86 and the bypass relay 88 are open, and the pre-charge contactor 82 and the main contactor 84 are open. If needed, the controller 65 operates one or more relays or contactors to ensure that all are open.

At block 202, the controller 65 determines whether the propulsion system 16 is active or enabled. If not, the method 200 returns to block 201.

At block 203, if the propulsion system 16 is enabled, the battery system 40 and high voltage devices including the inverters 24 and 34 are pre-charged to charge capacitances therein, using the battery pre-charge circuit including switches D2 and SPC. The battery relay 86 is closed and the voltage in the conversion device 78 is allowed to build up and charge the capacitors Cᵢₙ and Cₒᵤₜ.

At block 204, during pre-charge of the battery system 40, the controller 65 monitors the inverter voltage from the inverters 24 and 34, and an input voltage from the battery system 40, and calculates a difference therebetween. During the monitoring, the controller 65 continuously or periodically calculates the difference and compares the difference to a selected threshold. The controller 65 determines whether the difference is less than the threshold. If not (i.e., the difference is greater than or equal to the threshold), pre-charging continues at block 203.

At block 205, when the difference is less than the threshold, the pre-charge contactor 82 is closed (the main contactor 84 remains open). Voltage from the battery system 40 is adjusted by the conversion device 78 to the load voltage (e.g., 400 V) and used to pre-charge the one or more loads 74 by charging capacitances in the loads 74. The pre-charge circuit 80 limits current during the charging.

At block 206, the voltage of the one or more loads 74 is compared to the output voltage of the conversion device 78, and a difference between the voltages is compared to a second threshold. The controller 65 determines whether the difference is less than the second threshold. If not (i.e., if the difference is greater than or equal to the second threshold), pre-charging of the one or more loads 74 continues at block 205.

At block 207, when the difference is less than the second threshold, the pre-charge contactor 82 is opened and the main contactor 84 is closed. At this stage, the one or more loads 42 can be operated at the load voltage during vehicle propulsion.

Referring to FIG. 4, the method 210 of de-activating or shutting down the one or more loads 74 and the conversion system 70 includes a number of steps or stages represented by blocks 211-215. In an embodiment, the steps or stages are performed in the order presented. The method 210 is not limited to the number or order of steps therein, as some steps represented by blocks 211-215 may be performed in a different order than that described below, or fewer than all of the steps may be performed.

At block 211, the one or more loads 74 are operational and running at the load voltage supplied by the conversion system 70. The conversion system 70 is in the active mode in which the battery relay 86 is closed and the bypass relay 88 is open, the pre-charge contactor 82 is open and the main contactor 84 is closed.

At block 212, the controller 65 monitors the battery system 40 and/or propulsion system 16, and detects whether the propulsion system 16 has been de-activated or the battery system 40 has been disconnected. If not (i.e., the propulsion system is active and the battery system 40 is connected to the propulsion system 16), the conversion system 70 remains in the active mode (block 211).

At block 213, upon detecting that the propulsion system 16 has been de-activated or the battery system 40 has been disconnected (e.g., the switches S1-S4 are open), the one or more loads 74 are turned off or put into standby mode. The main contactor 84 is opened or turned off prior to disconnecting the conversion system 70 from the battery system 40 to prevent backfeeding the battery system 40.

At block 214, the voltage of the battery system 40 is monitored as the battery system 40 powers down and high voltage components discharge.

At block 215, when the output voltage reaches zero, or a value close to zero, the battery relay 86 is opened to complete de-activation of the conversion system 70.

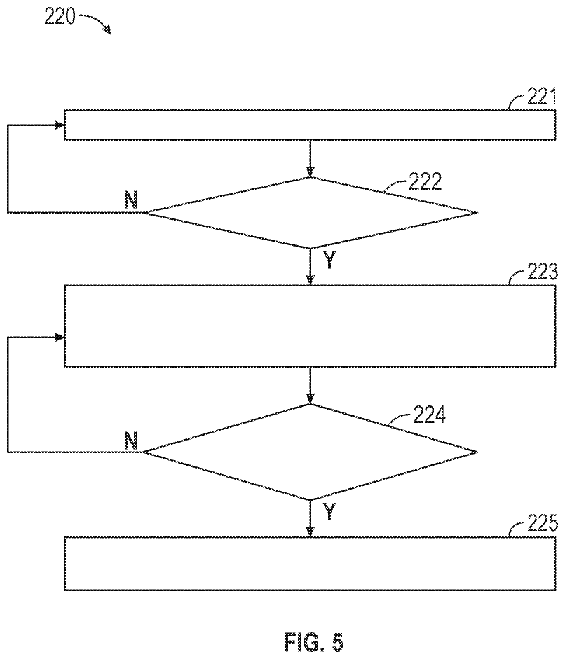

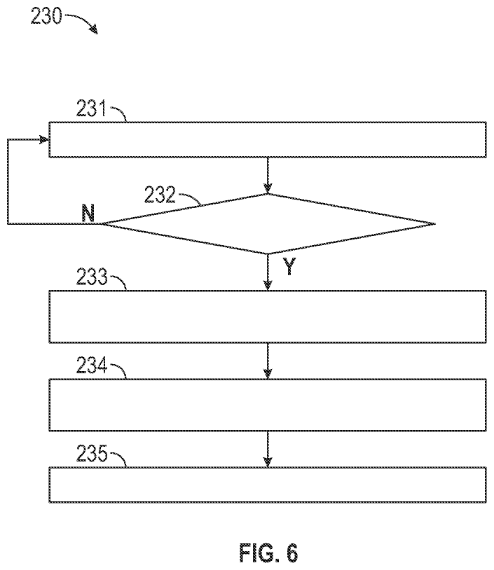

FIGS. 5 and 6 depict an embodiment of a method 220 of activating and supplying power to the one or more electrical loads 74, and an embodiment of a method 230 of de-activating the one or more electrical loads 74. The methods 220 and 230 are applicable in situations in which the battery system is in a high voltage mode or a low voltage mode and the voltage of the electrical loads (load voltage) is similar to the battery voltage. In such situations, the conversion system 70 is put into the bypass mode, in which the pre-charge circuit 80 may still be utilized to pre-charge the one or more loads 74, so that transients and inrush currents are eliminated or reduced.

The method 220 is described in conjunction with the battery system being in a low voltage mode (e.g., the battery voltage is 400 V). The method 220 is not so limited, as the method 220 can be performed for any battery system mode or battery voltage, where the battery voltage is the same as, or similar to, the load voltage.

Referring to FIG. 5, the method 220 includes a number of steps or stages represented by blocks 221-225. In an embodiment, the steps or stages are performed in the order presented. The method 220 is not limited to the number or order of steps therein, as some steps represented by blocks 221-225 may be performed in a different order than that described below, or fewer than all of the steps may be performed.

At block 221, the controller 65 determines whether the one or more loads 74 are off or in a standby mode. If the one or more loads 74 are not in the standby or off mode, the controller 65 puts the one or more loads 74 in the standby mode or sends a request to put the loads in standby.

The controller 65 also determines whether the conversion system 70 is in a standby mode. In the standby mode, the conversion device 78 is disconnected from the battery system 40, both the relay 86 and the bypass relay 88 are open, and the pre-charge contactor 82 and the main contactor 84 are open. If needed, the controller 65 operates one or more relays or contactors to ensure that all are open.

At block 222, the controller 65 determines whether the vehicle 10 is in a selected operating mode (e.g., propulsion mode, key on mode, etc.) or the selected operating mode is enabled. If not, the method 220 returns to block 221.

At block 223, if the operating mode is enabled, the battery system 40 and the one or more loads 74 are pre-charged simultaneously using the battery pre-charge circuit including switches S2 and SPC. The battery relay 86 is closed and voltage in the high voltage components (inverters 24 and 34, and any other high voltage components) connected to the battery system 40 is allowed to build up.

At block 224, during pre-charge of the battery system 40, the controller 65 monitors the voltage in the high voltage components and the voltage of the one or more loads 74, and calculates a difference therebetween. During the monitoring, the controller 65 continuously or periodically calculates the difference and compares the difference to a selected threshold. The controller 65 determines whether the difference is less than the threshold. If not (i.e., the difference is greater than or equal to the threshold), battery system pre-charging continues at block 223.

At block 225, when the difference is less than the threshold, the pre-charge contactor 82 is opened and the main contactor 84 is closed. At this stage, the loads 42 can be operated at the load voltage.

Referring to FIG. 6, the method 230 includes a number of steps or stages represented by blocks 231-235. In an embodiment, the steps or stages are performed in the order presented. The method 230 is not limited to the number or order of steps therein, as some steps represented by blocks 231-235 may be performed in a different order than that described below, or fewer than all of the steps may be performed.

At block 231, the one or more loads 74 are operational and running at the load voltage supplied by the conversion system 70. The conversion system 70 is in the bypass mode, the pre-charge contactor 82 is open and the main contactor 84 is closed.

At block 232, the controller 42 monitors the battery system 40 and/or propulsion system 16 to determine whether the vehicle 10 is no longer in the selected operating mode. If the vehicle 10 is in the selected operating mode, the conversion system 70 remains in the bypass mode (block 231).

At block 233, upon detecting that the vehicle 10 is no longer in the selected operating mode or the selected operating mode is disabled, the one or more loads 74 are turned off or put into standby mode. The main contactor 84 is opened or turned off prior to disconnecting the conversion system 70 from the battery system 40 to prevent backfeeding the battery system 40.

At block 234, the voltage of the battery system 40 is monitored as the battery system 40 powers down and high voltage components discharge.

At block 235, when the monitored voltage reaches zero, or a value close to zero, the bypass relay 88 is opened to complete de-activation of the conversion system 70.

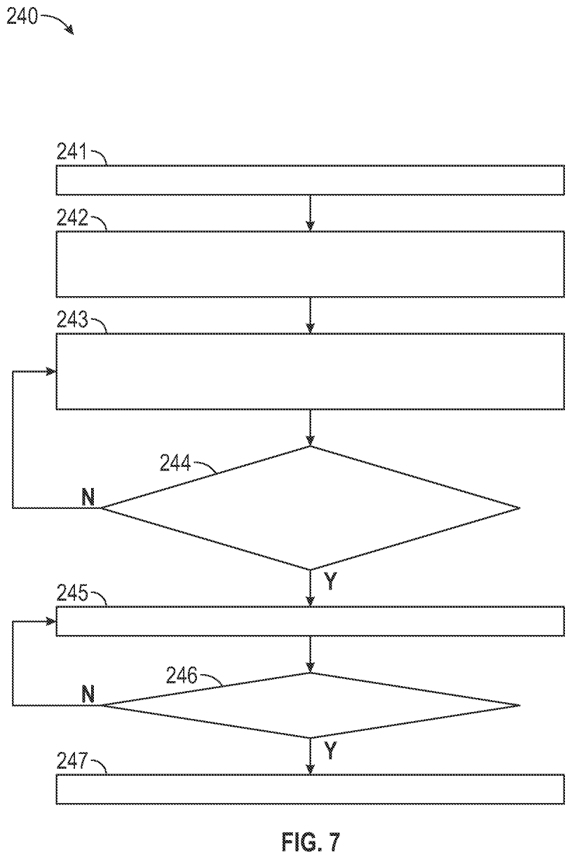

FIG. 7 depicts an embodiment of a method 240 of controlling voltage to electrical loads when transitioning between battery system operating modes and/or output voltage levels. The method 240 includes a number of steps or stages represented by blocks 241-247. The method 240 is not limited to the number or order of steps therein, as some steps represented by blocks 241-247 may be performed in a different order than that described below, or fewer than all of the steps may be performed.

At block 241, the propulsion system 16 is active, and the battery system 40 is in the high voltage mode (series mode). The one or more electrical loads 74 are operational and the conversion system 70 is operating to step down an input voltage (e.g., 800 V) to a load voltage (e.g., 400 V) to power the one or more electrical loads 74. The battery relay 86 is closed, the bypass relay 88 is open, and the pre-charge contactor 82 and the main contactor 84 are closed. The controller 65 monitors the battery system 40 and the propulsion system 16.

At block 242, the controller 65 is in communication with various vehicle systems (e.g., a vehicle controller or motor controller). If a request to transition the battery system 40 to the low voltage mode is received, or the controller detects that the battery system 40 is transitioning, the method proceeds to block 243.

At block 243, the controller 65 causes the one or more loads 74 to turn off or enter a standby mode. The main contactor 84 is opened, and the battery relay 86 is opened to isolate the conversion device 78. The controller 65 monitors the propulsion system voltage (e.g., inverter voltages) and an input voltage to the conversion device 78.

At block 244, The controller 65 also calculates a difference between the propulsion system voltage and a target voltage corresponding to the load voltage. For example, the load voltage is less than or equal to the voltage level associated with the low voltage mode (e.g., 400 V).

As the propulsion system voltage and the input voltage decrease, the controller 65 compares the difference to a threshold difference, and also compares the input voltage to the voltage level associated with the low voltage mode. The controller 65 determines whether the difference is less than the threshold difference. If not, monitoring continues at block 243.

At block 245, when the difference is less than the threshold difference and the input voltage drops below the voltage level associated with the low voltage mode, the bypass relay 88 is closed, and the pre-charge contactor 82 is closed. The controller 65 monitors the propulsion system voltage and the voltage of the one or more loads 74 as the capacitances in the one or more loads 74 charge.

At block 246, the controller 65 calculates a difference between the propulsion system voltage and the voltage of the one or more loads 74, and determines whether the difference is less than the threshold difference. If not, the method returns to block 245.

At block 247, when the difference is less than a threshold difference, or reaches zero, the main contactor 84 is closed, the one or more loads 74 are turned on, the power is supplied to the one or more loads 74 at the low voltage level.

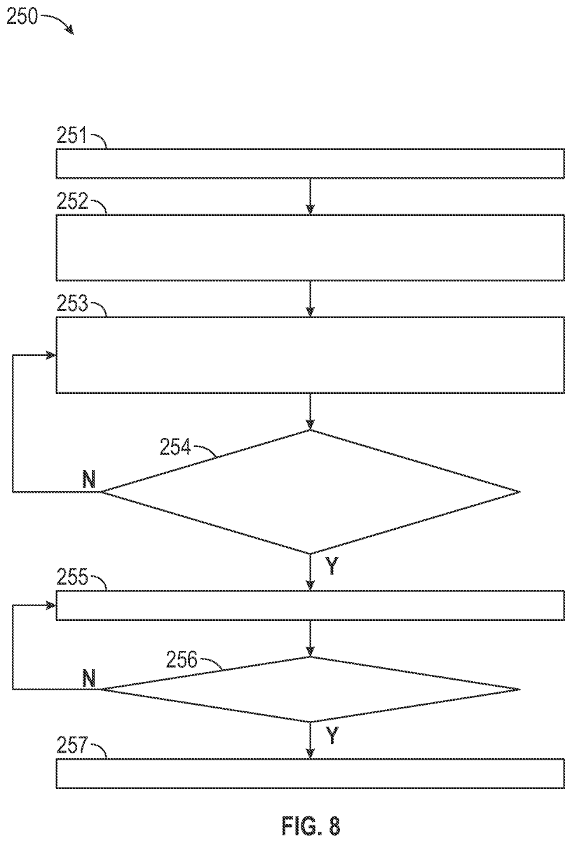

FIG. 8 depicts an embodiment of a method 250 of controlling voltage to electrical loads when transitioning between battery system operating modes and/or output voltage levels. The method 250 includes a number of steps or stages represented by blocks 251-257. The method 250 is not limited to the number or order of steps therein, as some steps represented by blocks 251-257 may be performed in a different order than that described below, or fewer than all of the steps may be performed.

At block 251, the propulsion system 16 is active, and the battery system 40 is in the low voltage mode (parallel mode). If the low voltage output from the battery system 40 is at least substantially the same as the load voltage, the pre-charge contactor 82 is open and the main contactor 84 is closed. The battery relay 86 is open and the bypass relay 88 is closed. The controller 65 monitors the battery system 40 and the propulsion system 16.

At block 252, the controller 65 is in communication with various vehicle systems (e.g., a vehicle controller or motor controller). If a request to transition the battery system 40 to the high voltage mode is received, or the controller detects that the battery system 40 is transitioning, the method proceeds to block 253.

At block 253, the controller 65 causes the one or more loads 74 to turn off or enter a standby mode. The main contactor 84 is opened, and the battery relay 88 is opened (or maintained at an open position) to isolate the conversion device 78, and the battery relay 86 is subsequently closed to begin a transition to the high voltage mode.

At block 254, the controller 65 monitors the propulsion system voltage (e.g., inverter voltages) and an input voltage to the conversion device 78. The controller 65 calculates a first difference between the propulsion system voltage and a target voltage corresponding to the load voltage. The controller 65 also calculates a second difference between an output voltage from the conversion device 78 and the load voltage.

As the propulsion system voltage and the input voltage increase, the controller 65 compares the first difference to a first threshold difference, and also compares the second difference to a second threshold difference.

The controller 65 determines whether the first difference is less than the first threshold difference and the second difference is less than the second threshold difference. If not, the voltages are allowed to continue to increase (block 253).

At block 255, if the first difference is less than the first threshold difference and the second difference is less than the second threshold difference, pre-charging is commenced by opening the main contactor 84 and closing the pre-charge contactor 82.

At block 256, the controller 65 monitors the propulsion system voltage and the voltage of the one or more loads 74 as the capacitances in the one or more loads 74 are pre-charged. The controller 65 also calculates a third difference between the output voltage from the conversion device 78 and the load voltage.

The controller 65 determines whether the third difference is less than a third threshold difference. The third difference threshold is less than the second difference, and may be zero or within a range of zero. If the third difference is not less than the third threshold difference, the pre-charging is allowed to continue.

At block 257, when the third difference is less than the third threshold difference, or reaches zero, the main contactor 84 is closed, the one or more loads 74 are turned on. Power is then supplied to the one or more loads 74 at the high voltage level.

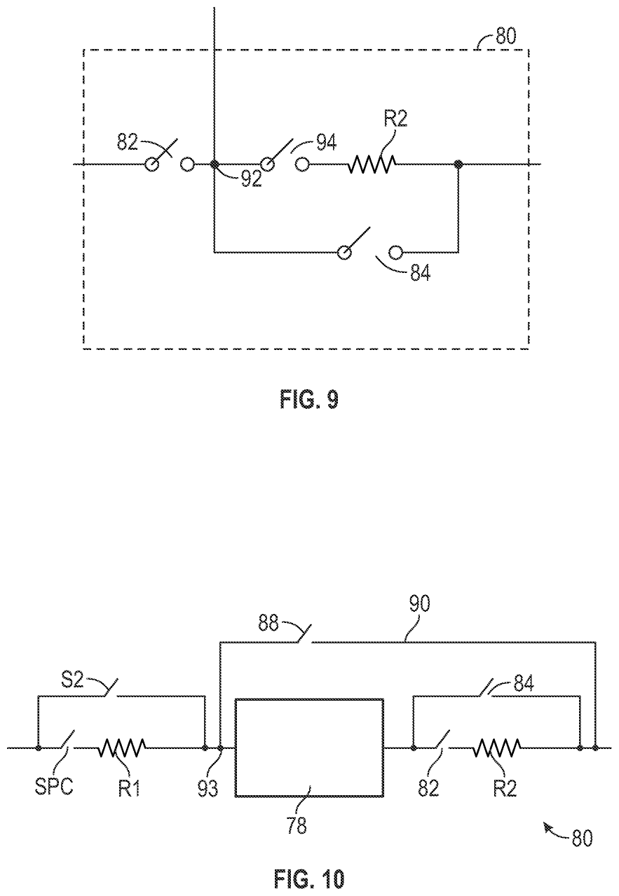

FIG. 9 depicts an alternative configuration of the conversion system 70. In this configuration, the pre-charge circuit 80 includes an additional switch or contactor 94 between the node 92 and the resistor R2. The contactor 94 may be closed when the pre-charge contactor is closed during pre-charging (in the normal mode), and opened when in the bypass mode so that any small amount of current through the pre-charge contactor is eliminated.

FIG. 10 depicts another embodiment of the conversion system. In this embodiment, the bypass contactor 90 bypasses the entire pre-charge circuit 80. For example, the bypass contactor 90 is connected at a node 93 between the pre-charge circuit and the loads 74. In this embodiment, the pre-charge components in the battery system (switch S2, switch SPC and resistor R1) may be used to pre-charge the one or more loads 74 when switching between high voltage and low voltage modes.

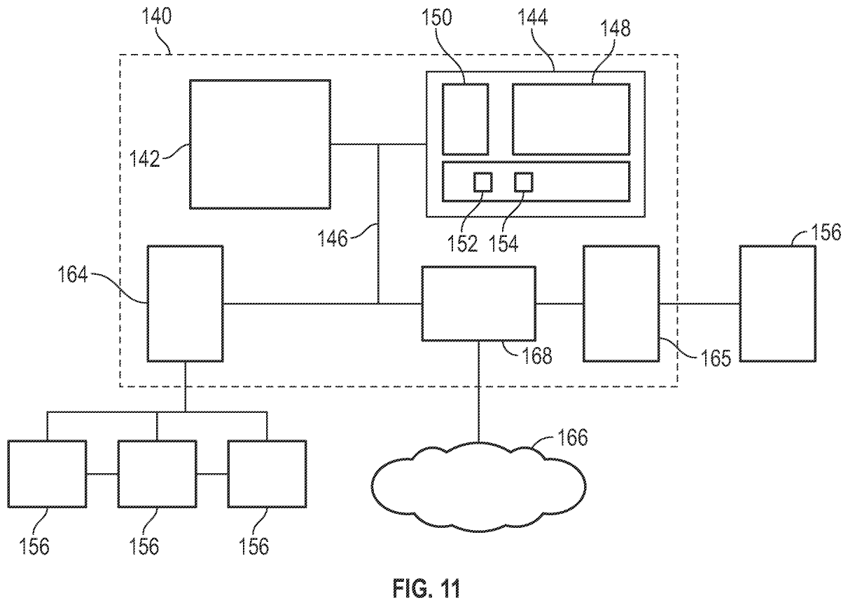

FIG. 11 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring components (e.g., the propulsion system, battery system, electrical loads, etc.), and a module 154 may be included to perform functions related to controlling the conversion system. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for supplying power to one or more electrical loads in a vehicle, comprising:
a conversion system connected to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to the one or more electrical loads; and
a controller configured to operate the conversion system to electrically connect the conversion device and the pre-charge circuit to the battery system and the one or more electrical loads, the controller configured to adjust a battery system voltage from the battery system to a load voltage of the one or more electrical loads based on a mismatch between the battery system voltage and the load voltage.

2. The system of claim 1, wherein the conversion system is selectively connected to the one or more electrical loads by a second bus separate from the propulsion bus, the second bus configured to support voltage levels provided by the battery system.

3. The system of claim 1, wherein the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

4. The system of claim 3, wherein the controller is configured to electrically connect the conversion system by sequentially performing:
electrically connecting the propulsion system to the battery system, and closing the first switch to electrically connect the battery system to the conversion device, wherein the pre-charge contactor and the main contactor are open;
pre-charging the propulsion system and the conversion device using pre-charge components in the battery system;
monitoring a propulsion system voltage, an input voltage to the conversion device, and an output voltage from the conversion device;
based on a difference between the propulsion system voltage and the input voltage being less than a threshold difference, and based on the output voltage reaching a selected voltage level, closing the pre-charge contactor to pre-charge one or more capacitors of the one or more electrical loads;
monitoring a voltage of the one or more electrical loads during the pre-charge; and
based on the voltage of one or more electrical loads being within a selected range of the output voltage, closing the main contactor and adjusting the input voltage by the conversion device.

5. The system of claim 4, wherein the battery system includes a first battery assembly and a second battery assembly, and the battery system is in a high voltage mode in which the first battery assembly and the second battery assembly are electrically connected in series.

6. The system of claim 3, wherein the battery system voltage is the same as the load voltage or the battery system voltage is within a selected range of the load voltage, and the controller is configured to electrically connect the conversion system by sequentially performing:
electrically connecting the propulsion system to the battery system, and closing the second switch to bypass the conversion device and electrically connect the battery system to the pre-charge circuit, wherein the pre-charge contactor and the main contactor are open;
closing the pre-charge contactor and opening the main contactor;
simultaneously pre-charging the propulsion system and the one or more electrical loads;
monitoring a voltage of the one or more electrical loads during the pre-charge; and
based on the voltage of one or more electrical loads being within a selected range of an output voltage from the conversion device, closing the main contactor and powering the one or more electrical loads using the battery system voltage.

7. The system of claim 3, wherein the battery system includes a first battery assembly and a second battery assembly, the battery system is configured to be put into a high voltage mode by electrically connecting the first battery assembly and the second battery assembly in series, and the battery system is configured to be put into a low voltage mode by electrically connecting the first battery assembly and the second battery assembly in parallel.

8. The system of claim 7, wherein the propulsion system is active, the battery system is in the high voltage mode, the first switch, the pre-charge contactor and the main contactor are closed, and the controller is configured to perform:
operating the conversion device to adjust an input voltage to a target voltage that is less than or equal to a voltage level corresponding to the low voltage mode;
receiving a request to transition the battery system from the high voltage mode to the low voltage mode;
opening the first switch and the main contactor to isolate the conversion device;
monitoring a propulsion system voltage and an input voltage to the conversion device;
based on a difference between the propulsion system voltage and the target voltage being less than a threshold difference, and based on the input voltage being less than the target voltage, closing the second switch and opening the main contactor to pre-charge one or more capacitors of the one or more electrical loads;
monitoring a voltage of the one or more electrical loads during the pre-charge; and
based on the voltage of one or more electrical loads being within a selected range of the target voltage, closing the main contactor and powering the one or more electrical loads using the battery voltage in the low voltage mode.

9. The system of claim 7, wherein the propulsion system is active, the battery system is in the low voltage mode, the first switch is open and the second switch is closed, the pre-charge contactor is open and the main contactor is closed, and the controller is configured to perform:
receiving a request to transition the battery system from the low voltage mode to the high voltage mode;
opening the second switch and the main contactor to isolate the conversion device, and subsequently closing the first switch;
monitoring a propulsion system voltage and an input voltage to the conversion device, and monitoring an output voltage from the conversion device;
based on a first difference between the propulsion system voltage and a target voltage being less than a first threshold difference, and based on a second difference between the output voltage and the load voltage being less than a second threshold difference, closing the pre-charge contactor and opening the main contactor to pre-charge one or more capacitors of the one or more electrical loads;
monitoring a voltage of the one or more electrical loads during the pre-charge; and
based on a third difference between the voltage of one or more electrical loads and the output voltage of the conversion device being less than a third threshold difference, closing the main contactor and powering the one or more electrical loads using the battery voltage in the high voltage mode.

10. A method of supplying power to one or more electrical loads in a vehicle, comprising:
electrically connecting a conversion system to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to the one or more electrical loads;
pre-charging the one or more electrical loads using the pre-charge circuit or pre-charge components in the battery system; and
based on a mismatch between a battery system voltage and a load voltage of the one or more electrical loads, adjusting the battery system voltage to the load voltage.

11. The method of claim 10, wherein the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

12. The method of claim 11, wherein electrically connecting the conversion system includes sequentially performing:
electrically connecting the propulsion system to the battery system, and closing the first switch to electrically connect the battery system to the conversion device, wherein the pre-charge contactor and the main contactor are open;
pre-charging the propulsion system and the conversion device using pre-charge components in the battery system;
monitoring a propulsion system voltage, an input voltage to the conversion device, and an output voltage from the conversion device;
based on a difference between the propulsion system voltage and the input voltage being less than a threshold difference, and based on the output voltage reaching a selected voltage level, closing the pre-charge contactor to pre-charge one or more capacitors of the one or more electrical loads;
monitoring a voltage of the one or more electrical loads during the pre-charge; and
based on the voltage of one or more electrical loads being within a selected range of the output voltage, closing the main contactor and adjusting the input voltage by the conversion device.

13. The method of claim 11, wherein the battery system voltage is the same as the load voltage or the battery system voltage is within a selected range of the load voltage, and electrically connecting the conversion system includes sequentially performing:
electrically connecting the propulsion system to the battery system, and closing the second switch to bypass the conversion device and electrically connect the battery system to the pre-charge circuit, wherein the pre-charge contactor and the main contactor are open;
closing the pre-charge contactor and opening the main contactor;
simultaneously pre-charging the propulsion system and the one or more electrical loads;
monitoring a voltage of the one or more electrical loads during the pre-charge; and
based on the voltage of one or more electrical loads being within a selected range of an output voltage from the conversion device, closing the main contactor and powering the one or more electrical loads using the battery system voltage.

14. The method of claim 11, wherein the battery system includes a first battery assembly and a second battery assembly, the battery system is configured to be put into a high voltage mode by electrically connecting the first battery assembly and the second battery assembly in series, and the battery system is configured to be put into a low voltage mode by electrically connecting the first battery assembly and the second battery assembly in parallel.

15. The method of claim 14, wherein the propulsion system is active, the battery system is in the high voltage mode, the first switch, the pre-charge contactor and the main contactor are closed, and the method includes:
operating the conversion device to adjust an input voltage to a target voltage that is less than or equal to a voltage level corresponding to the low voltage mode;
receiving a request to transition the battery system from the high voltage mode to the low voltage mode;
opening the first switch and the main contactor to isolate the conversion device;
monitoring a propulsion system voltage and an input voltage to the conversion device;
based on a difference between the propulsion system voltage and the target voltage being less than a threshold difference, and based on the input voltage being less than the target voltage, closing the second switch and opening the main contactor to pre-charge one or more capacitors of the one or more electrical loads;
monitoring a voltage of the one or more electrical loads during the pre-charge; and
based on the voltage of one or more electrical loads being within a selected range of the target voltage, closing the main contactor and powering the one or more electrical loads using the battery voltage in the low voltage mode.

16. A vehicle system comprising:
a memory having computer readable instructions; and
a processing device for executing the computer readable instructions, the computer readable instructions controlling the processing device to perform a method including:
electrically connecting a conversion system to a battery system, the battery system configured to provide a voltage to a propulsion system of the vehicle via a propulsion bus, the conversion system including a conversion device and a pre-charge circuit selectively connected to the propulsion bus by a first switch, the conversion system selectively connected to one or more electrical loads;
pre-charging the one or more electrical loads using the pre-charge circuit or pre-charge components in the battery system; and
based on a mismatch between a battery system voltage and a load voltage of the one or more electrical loads, adjusting the battery system voltage to the load voltage.

17. The vehicle system of claim 16, wherein the pre-charge circuit includes a pre-charge contactor connected in series to a pre-charge resistor, and a main contactor connected in parallel with the pre-charge resistor, the conversion device connected to the pre-charge contactor, and the conversion system includes a bypass contactor connected to the battery system and a second switch at the bypass contactor, the bypass contactor configured to bypass the conversion device when the second switch is closed.

18. The vehicle system of claim 17, wherein electrically connecting the conversion system includes sequentially performing:
electrically connecting the propulsion system to the battery system, and closing the first switch to electrically connect the battery system to the conversion device, wherein the pre-charge contactor and the main contactor are open;
pre-charging the propulsion system and the conversion device using pre-charge components in the battery system;
monitoring a propulsion system voltage, an input voltage to the conversion device, and an output voltage from the conversion device;
based on a difference between the propulsion system voltage and the input voltage being less than a threshold difference, and based on the output voltage reaching a selected voltage level, closing the pre-charge contactor to pre-charge one or more capacitors of the one or more electrical loads;
monitoring a voltage of the one or more electrical loads during the pre-charge; and
based on the voltage of one or more electrical loads being within a selected range of the output voltage, closing the main contactor and adjusting the input voltage by the conversion device.

19. The vehicle system of claim 18, wherein the battery system includes a first battery assembly and a second battery assembly, and the battery system is in a high voltage mode in which the first battery assembly and the second battery assembly are electrically connected in series.

20. The vehicle system of claim 17, wherein the battery system voltage is the same as the load voltage or the battery system voltage is within a selected range of the load voltage, and electrically connecting the conversion system includes sequentially performing:
electrically connecting the propulsion system to the battery system, and closing the second switch to bypass the conversion device and electrically connect the battery system to the pre-charge circuit, wherein the pre-charge contactor and the main contactor are open;
closing the pre-charge contactor and opening the main contactor;
simultaneously pre-charging the propulsion system and the one or more electrical loads;
monitoring a voltage of the one or more electrical loads during the pre-charge; and
based on the voltage of one or more electrical loads being within a selected range of an output voltage from the conversion device, closing the main contactor and powering the one or more electrical loads using the battery system voltage.
